(19) United States
(12) Patent Application Publication
(10) Pub. No.: US 2024/0084220 A1
(43) Pub. Date: Mar. 14, 2024

(54) AQUEOUS LIGHT DUTY LIQUID DETERGENT FORMULATION

(71) Applicant: Dow Silicones Corporation, Midland, MI (US)

(72) Inventors: Saugata Nad, Brussels (BE); Serge Creutz, Liege (BE); Christel Simon, Lobbes (BE)

(21) Appl. No.: 18/259,657

(22) PCT Filed: Feb. 22, 2022
(86) PCT No.: PCT/US2022/017186

§ 371 Date: Jun. 28, 2023

Related U.S. Application Data
(60) Provisional application No. 63/153,400, filed on Feb. 25, 2021.

(51) Int. Cl. C11D 1/94; C11D 11/00

(52) U.S. Cl. CPC C11D 1/94; C11D 11/0035; C11D 3/3951

(57) ABSTRACT

An aqueous light duty liquid detergent formulation, is provided including water; a cleaning surfactant; and a suds enhancing additive; wherein the suds enhancing additive comprises a crosslinked cellulose ether containing 0.1 to 0.6 wt %, based on weight of the crosslinked cellulose ether, of polyether groups.

The present invention relates to an aqueous light duty liquid detergent formulation. In particular, the present invention relates to an aqueous light duty liquid detergent formulation including water; a cleaning surfactant; and a suds enhancing additive; wherein the suds enhancing additive comprises a crosslinked cellulose ether containing 0.1 to 0.6 wt %, based on weight of the crosslinked cellulose ether, of polyether groups.

Aqueous cleaning compositions, for example, hard surface cleaning formulations have a wide array of uses. For example, use cleaning hard surfaces such as floors, counters, walls, tables, and other things made of, for example, wood, stone, laminate, ceramic and plastic materials which need to be cleaned periodically of accumulated dirt, oil, grease, and other contaminants. The best surfactants for hard surface cleaning formulations tend to irritate the skin of some users. More mild surfactants, however, tend to negatively impact suds mileage which has long been a recognized signal for the continued effectiveness of the detergent formulation in use.

Duliba et al. provide a light duty liquid detergent formulation in U.S. Pat. No. 5,424,010. Duliba et al disclose a light duty, liquid hand washing composition which is mild, stable foaming composition especially effective in cleaning dishware, glasses, flatware, pots, pans, and delicate clothing by hand at ambient wash water temperature, as well as at warm or hot wash water temperatures. The composition comprises from about 20% to about 40% by weight of at least one anionic or nonionic surfactant; from about 0.5 to about 3.5% by weight of an alcohol which is 3-methyl-3-methoxy-butanol: from about 2% to about 8% of at least one hydrotrope; and from about 50% to about 70% water. The composition has a pH in the range of from about 6.0 to about 8.0 and a viscosity in the range of from about MO cps to about 500 cps.

Notwithstanding, there remains a continuing need for effective aqueous liquid hand dishwashing detergent formulations having improved aesthetic characteristics (particularly hand feel) and maintained suds mileage and/or improved flash suds.

The present invention provides an aqueous light duty liquid detergent formulation, comprising: water; a cleaning surfactant; and a suds enhancing additive; wherein the suds enhancing additive comprises a crosslinked cellulose ether containing 0.1 to 0.6 wt %, based on weight of the crosslinked cellulose ether, of polyether groups.

The present invention provides a method of manually washing an article, comprising: providing a soiled article, wherein the soiled article is selected from the group consisting of at least one of dishware, glassware, flatware, pots and pans; providing an aqueous light duty liquid detergent formulation of the present invention; manually contacting the soiled article with the aqueous light duty liquid detergent formulation to provide a cleaned article; and rinsing the aqueous light duty liquid detergent formulation from the cleaned article.

### DETAILED DESCRIPTION

The aqueous light duty liquid detergent formulations of the present invention provide effective cleaning performance with enhanced suds mileage in the presence of greasy food soils while improving aesthetic characteristics, particularly rheology, suspension and hand feel.

Unless otherwise indicated, ratios, percentages, parts, and the like are by weight. Weight percentages (or wt %) in the composition are percentages of dry weight, i.e., excluding any water that may be present in the composition. Percentages of monomer units in the polymer are percentages of solids weight, i.e., excluding any water present in a polymer emulsion.

As used herein, unless otherwise indicated, the terms “weight average molecular weight” and “Mw” are used interchangeably to refer to the weight average molecular weight as measured in a conventional manner with gel permeation chromatography (GPC) and conventional standards, such as polyethylene glycol standards. GPC techniques are discussed in detail in Modem Size Exclusion Chromatography, W. W. Yau, J. J. Kirkland, D. D. Bly; Wiley-lnterscience, 1979, and in A Guide to Materials Characterization and Chemical Analysis, J. P. Sibilia; VCH, 1988, p. 81-84. Weight average molecular weights are reported herein in units of Daltons.

The term “DS” as used herein and in the appended claims means the number of alkyl substituted OH groups per anhydroglucose unit in a cellulose ether, as determined by the Zeisel Method.

The term “DS (methyl)” or “DS (M)” as used herein and in the appended claims means the number of methyl substituted OH groups per anhydroglucose unit in a cellulose ether, as determined by the Zeisel Method.

The term “MS” as used herein and in the appended claims means the number of moles of etherification reagent which are bound as ether per mol of anhydroglucose unit as hydroxyalkyl substituents in a cellulose ether, as determined by the Zeisel Method.

The term “MS (hydroxyethyl)” or “MS (HE)” as used herein and in the appended claims means the number of moles of etherification reagent which are bound as ether per mol of anhydroglucose unit as hydroxyethyl substituents in a cellulose ether, as determined by the Zeisel Method.

The term “MS (hydroxypropyl)” or “MS (HP)” as used herein and in the appended claims means the number of moles of etherification reagent which are bound as ether per mol of anhydroglucose unit as hydroxypropyl substituents in a cellulose ether, as determined by the Zeisel Method.

The term “Zeisel Method” refers to the Zeisel cleavage procedure for determination of MS and DS. See G. Bartelmus and R. Ketterer, Zeitschrift fuer Analytische Chemie, Vol. 286 (1977, Springer, Berline, DE), pages 161-190.

The term “aesthetic characteristics” as used herein and in the appended claims in reference to an aqueous liquid hand dishwashing detergent formulation refers to visual and tactile sensory properties (e.g., smoothness, tack, lubricity, texture, color, clarity, turbidity, uniformity).

Preferably, the aqueous light duty liquid detergent formulation of the present invention is selected from the group consisting of a hard surface cleaning formulation and a hand dishwashing formulation. More preferably, the aqueous light duty liquid detergent formulation of the present invention is a hand dishwashing formulation.

Preferably, the aqueous light duty liquid detergent formulation of the present invention, comprises: water (preferably, 10 to 99 wt % (more preferably, 25 to 98 wt %; most preferably, 50 to 97 wt %), based on the weight of the aqueous light duty liquid detergent formulation, of the water); a cleaning surfactant (preferably, 0.01 to 35 wt % (more preferably, 0.1 to 20 wt %; still more preferably, 1 to 15 wt %; most preferably, 5 to 12 wt %), based on the weight of the aqueous light duty liquid detergent formulation, of the cleaning surfactant); and a suds enhancing additive (preferably, 0.01 to 5 wt %; more preferably, 0.05 to 3 wt %; still more preferably, 0.075 to 1 wt %; most preferably, 0.1 to 0.5 wt %), based on weight of the aqueous light duty liquid detergent formulation, of the suds enhancing additive); wherein the suds enhancing additive comprises a crosslinked cellulose ether containing 0.1 to 0.6 wt %, based on weight of the crosslinked cellulose ether, of polyether groups.

Preferably, the aqueous light duty liquid detergent formulation of the present invention, comprises: 10 to 99 wt % (preferably, 25 to 98 wt %; more preferably, 50 to 97 wt %), based on the weight of the aqueous light duty liquid detergent formulation, of the water. More preferable, the aqueous light duty liquid detergent formulation of the present invention, comprises 10 to 99 wt % (preferably, 25 to 98 wt %; more preferably, 50 to 97 wt %), based on the weight of the aqueous light duty liquid detergent formulation, of the water; wherein the water is at least one of distilled water, deionized water and industrial soft water. Still more preferably, the aqueous light duty liquid detergent formulation of the present invention, comprises 10 to 99 wt % (preferably, 25 to 98 wt %; more preferably, 50 to 97 wt %), based on the weight of the aqueous light duty liquid detergent formulation, of the water; wherein the water is distilled and deionized. Most preferably, the aqueous light duty liquid detergent formulation of the present invention, comprises 10 to 99 wt % (preferably, 25 to 98 wt %; more preferably, 50 to 97 wt %), based on the weight of the aqueous light duty liquid detergent formulation, of the water; wherein the water is distilled, deionized and industrial soft to avoid introduction of undesirable metal ions to the aqueous light duty liquid detergent formulation.

Preferably, the aqueous light duty liquid detergent formulation of the present invention comprises a cleaning surfactant; wherein the cleaning surfactant is selected from the group consisting of nonionic surfactants, anionic surfactants, cationic surfactants, zwitterionic surfactants, amphoteric surfactants and mixtures thereof. Preferably, the aqueous light duty liquid detergent formulation of the present invention comprises 0.01 to 35 wt % (preferably, 0.1 to 20 wt %; more preferably, 1 to 15 wt %; most preferably, 5 to 12 wt %), based on the weight of the aqueous light duty liquid detergent formulation, of a cleaning surfactant; wherein the cleaning surfactant is selected from the group consisting of nonionic surfactants, anionic surfactants, cationic surfactants, zwitterionic surfactants, amphoteric surfactants and mixtures thereof. Still more preferably, the aqueous light duty liquid detergent formulation of the present invention comprises 0.01 to 35 wt % (preferably, 0.1 to 20 wt %; more preferably, 1 to 15 wt %; most preferably, 5 to 12 wt %), based on the weight of the aqueous light duty liquid detergent formulation, of a cleaning surfactant; wherein the cleaning surfactant includes an anionic surfactant. Yet more preferably, the aqueous light duty liquid detergent formulation of the present invention comprises 0.01 to 35 wt % (preferably, 0.1 to 20 wt %; more preferably, 1 to 15 wt %; most preferably, 5 to 12 wt %), based on the weight of the aqueous light duty liquid detergent formulation, of a cleaning surfactant; wherein the cleaning surfactant includes a mixture of anionic surfactants. Still yet more preferably, the aqueous light duty liquid detergent formulation of the present invention comprises 0.01 to 35 wt % (preferably, 0.1 to 20 wt %; more preferably, 1 to 15 wt %; most preferably, 5 to 12 wt %), based on the weight of the aqueous light duty liquid detergent formulation, of a cleaning surfactant; wherein the cleaning surfactant includes a mixture of an anionic surfactant and an amphoteric surfactant. Most preferably, the aqueous light duty liquid detergent formulation of the present invention comprises 0.01 to 35 wt % (preferably, 0.1 to 20 wt %; more preferably, 1 to 15 wt %; most preferably, 5 to 12 wt %), based on the weight of the aqueous light duty liquid detergent formulation, of a cleaning surfactant; wherein the cleaning surfactant includes a mixture of a linear alkyl benzene sulfonic acid (LABSA) or salt thereof, a sodium lauryl ether sulfate (SLES) and a cocamidopropyl betaine.

Preferably, the anionic surfactant is selected from the group consisting of alkyl sulfonic acids, alkyl sulfates, alkyl sulfonates, alkyl benzene sulfonic acid, alkyl benzene sulfates, alkyl benzene sulfonates, alkyl ether sulfonic acids, alkyl ether sulfates, alkyl ether sulfonates, paraffin sulfonic acids, paraffin sulfates, paraffin sulfonates, olefin sulfonic acids, olefin sulfates, olefin sulfonates, alpha-sulfocarboxylates, esters of alpha-sulfocarboxylates, alkyl glyceryl ether sulfonic acids, alkyl glyceryl ether sulfates, alkyl glyceryl ether sulfonates, sulfates of fatty acids, sulfonates of fatty acids, sulfonates of fatty acid esters, alkyl phenol polyethoxy ether sulfates, 2-acryloxy-alkane-1-sulfonic acid, 2-acryloxy-alkane-1-sulfonate, beta-alkyloxy alkane sulfonic acid, beta-alkyloxy alkane sulfonate, salts thereof and mixtures thereof. More preferably, the anionic surfactant is selected from the group consisting of C₈₋₂₀ alkyl benzene sulfonic acid, C₈₋₂₀ alkyl benzene sulfates, C₈₋₂₀ alkyl benzene sulfonate, C₈₋₂₀ alkyl ether sulfonic acids, C₈₋₂₀ alkyl ether sulfates, C₈₋₂₀ alkyl ether sulfonates, paraffin sulfonic acid, paraffin sulfates, paraffin sulfonate, alpha-olefin sulfonic acid, alpha-olefin sulfate, alpha-olefin sulfonate, sulfonates of fatty acids, sulfonates of fatty acid esters, salts thereof and mixtures thereof. Still more preferably the anionic surfactant is selected from the group consisting of C₁₁₋₁₃ alkyl benzene sulfonic acid, C₁₁₋₁₃ alkyl benzene sulfonate, C₁₁₋₁₃ alkyl polyethoxy sulfonic acids, C₁₁₋₁₃ alkyl polyethoxy sulfates, C₁₁₋₁₃ alkyl polyethoxy sulfonates, salts thereof and mixtures thereof. Yet more preferably the anionic surfactants is selected from the group consisting of C₁₀₋₁₆ alkyl benzene sulfonic acid, C₁₀₋₁₆ alkyl benzene sulfonate, C₁₀₋₁₆ alkyl polyethoxy sulfonic acids, C₁₀₋₁₆ alkyl polyethoxy sulfates, C₁₀₋₁₆ alkyl polyethoxy sulfonates, salts thereof and mixtures thereof. Most preferably the anionic surfactant includes (preferably, is) a mixture of sodium lauryl ether sulfate (SLES) and C₁₀₋₁₆ alkyl benzene sulfonic acid or salt thereof.

Preferably, the amphoteric surfactant is selected from the group consisting of betaines, amine oxides, alkylamidoalkylamines, alkyl-substituted amine oxides, acylated amino acids, derivatives of aliphatic quaternary ammonium compounds and mixtures thereof. More preferably, the amphoteric surfactant includes a betaine. Most preferably, the amphoteric surfactant is a cocamidopropyl betaine.

Non-ionic surfactants include alkoxylates, polyglycol ethers, fatty alcohol polyglycol ethers, alkylphenol polyglycol ethers, end group capped polyglycol ethers, mixed ethers, hydroxy mixed ethers, fatty acid polyglycol esters and mixtures thereof. Preferred non-ionic surfactants include alkoxylates. More preferred non-ionic surfactants are according to formula I

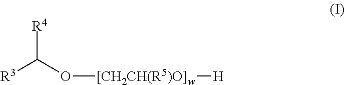

wherein w is an average of 5 to 40 (preferably, 7 to 27; more preferably, 8 to 20; most preferably, 7 to 12); wherein R³ is selected from the group consisting of a hydrogen and a linear or branched C₁₋₂₀ alkyl group (preferably, a hydrogen, and a linear or branched C₁₋₁₅ alkyl group; more preferably, a linear C₁₋₁₅ alkyl group); wherein R⁴ is selected from the group consisting of a linear or branched C₁₋₂₀ alkyl group and a linear or branched C₁₋₄ hydroxyalkyl group (preferably, a linear or branched C₁₋₁₅ alkyl group and a linear or branched C₁₋₄ hydroxyalkyl group; more preferably, a linear C₁₋₁₅ alkyl group and a linear or branched C₁₋₃ hydroxyalkyl group; most preferably, a linear C₁₋₁₅ alkyl group); wherein each R⁵ is independently selected from the group consisting of a hydrogen, a methyl group, an ethyl group, a n-propyl group, an iso-propyl group, a n-butyl group, a 2-butyl group and a 2-methyl-2-butyl group (preferably, a hydrogen, a methyl group and an ethyl group; more preferably, a hydrogen and a methyl group; most preferably, a hydrogen); and with the proviso that sum of the total number of carbon atoms in R³ and R⁴ is 5 to 21 (preferably, 6 to 20 carbon atoms; more preferably, 7 to 18 carbon atoms; most preferably, 11 to 15 carbon atoms). Still more preferred nonionic surfactants are according to formula I; wherein w is an average of 8 to 16; wherein R³ is selected from the group consisting of a hydrogen and a linear C₁₋₁₅ alkyl group; wherein R⁴ is selected from the group consisting of a linear or branched C₁₋₁₅ alkyl group and a linear or branched C₁₋₄ hydroxyalkyl; wherein R⁵ is selected from the group consisting of a hydrogen, a methyl group and an ethyl group; and with the proviso that the sum of the total number of carbon atoms in R³ and R⁴ is 6 to 20. Most preferred nonionic surfactants are according to formula I; wherein w is an average of 7 to 12; wherein R³ is selected from the group consisting of a hydrogen and a linear C₁₋₁₅ alkyl group; wherein R⁴ is selected from the group consisting of a linear C₁₋₁₅ alkyl group and a linear or branched C₁₋₃ hydroxyalkyl group; wherein R⁵ is a hydrogen; and with the proviso that the sum of the total number of carbon atoms in R³ and R⁴ is 7 to 18.

Preferably, the aqueous light duty liquid detergent formulation of the present invention, comprises: 0.01 to 5 wt % (preferably, 0.05 to 3 wt %; more preferably, 0.075 to 1 wt %; most preferably, 0.1 to 0.5 wt %), based on weight of the aqueous light duty liquid detergent formulation, of a suds enhancing additive; wherein the suds enhancing additive comprises a crosslinked cellulose ether containing 0.1 to 0.6 wt %, based on weight of the crosslinked cellulose ether, of polyether groups. More preferably, the aqueous light duty liquid detergent formulation of the present invention, comprises: 0.01 to 5 wt % (preferably, 0.05 to 3 wt %; more preferably, 0.075 to 1 wt %; most preferably, 0.1 to 0.5 wt %), based on weight of the aqueous light duty liquid detergent formulation, of a suds enhancing additive; wherein the suds enhancing additive comprises a crosslinked cellulose ether containing 0.1 to 0.6 wt %, based on weight of the crosslinked cellulose ether, of polyether groups; wherein the crosslinked cellulose ether comprises a base cellulose ether and crosslinks; wherein the crosslinks contain the polyether groups and wherein the base cellulose ether is a mixed cellulose ether containing hydroxyalkyl ether groups and alkyl ether groups. Still more preferably, the aqueous light duty liquid detergent formulation of the present invention, comprises: 0.01 to 5 wt % (preferably, 0.05 to 3 wt %; more preferably, 0.075 to 1 wt %; most preferably, 0.1 to 0.5 wt %), based on weight of the aqueous light duty liquid detergent formulation, of a suds enhancing additive; wherein the suds enhancing additive comprises a crosslinked cellulose ether containing 0.1 to 0.6 wt %, based on weight of the crosslinked cellulose ether, of polyether groups; wherein the crosslinked cellulose ether comprises a base cellulose ether and crosslinks; wherein the crosslinks contain the polyether groups and wherein the base cellulose ether is selected from the group consisting of hydroxyethyl methylcellulose, hydroxypropyl methyl cellulose, methyl hydroxyethyl hydroxypropylcellulose, ethyl hydroxyethyl cellulose and combinations thereof. Most preferably, the aqueous light duty liquid detergent formulation of the present invention, comprises: 0.01 to 5 wt % (preferably, 0.05 to 3 wt %; more preferably, 0.075 to 1 wt %; most preferably, 0.1 to 0.5 wt %), based on weight of the aqueous light duty liquid detergent formulation, of a suds enhancing additive; wherein the suds enhancing additive comprises a crosslinked cellulose ether containing 0.1 to 0.6 wt %, based on weight of the crosslinked cellulose ether, of polyether groups; wherein the crosslinked cellulose ether comprises a base cellulose ether and crosslinks; wherein the crosslinks contain the polyether groups and wherein the base cellulose ether is hydroxyethyl methylcellulose.

Preferably, the aqueous light duty liquid detergent formulation of the present invention, comprises: 0.01 to 5 wt % (preferably, 0.05 to 3 wt %; more preferably, 0.075 to 1 wt %; most preferably, 0.1 to 0.5 wt %), based on weight of the aqueous light duty liquid detergent formulation, of a suds enhancing additive; wherein the suds enhancing additive comprises a crosslinked cellulose ether containing 0.1 to 0.6 wt %, based on weight of the crosslinked cellulose ether, of polyether groups and wherein the crosslinked cellulose either is an irreversibly crosslinked cellulose ether. More preferably, the aqueous light duty liquid detergent formulation of the present invention, comprises: 0.01 to 5 wt % (preferably, 0.05 to 3 wt %; more preferably, 0.075 to 1 wt %; most preferably, 0.1 to 0.5 wt %), based on weight of the aqueous light duty liquid detergent formulation, of a suds enhancing additive; wherein the suds enhancing additive comprises a crosslinked cellulose ether containing 0.1 to 0.6 wt %, based on weight of the crosslinked cellulose ether, of polyether groups; wherein the crosslinked cellulose ether comprises a base cellulose ether and crosslinks; wherein the crosslinks contain the polyether groups; wherein the base cellulose ether is a mixed cellulose ether containing hydroxyalkyl ether groups and alkyl ether groups and wherein the crosslinked cellulose either is an irreversibly crosslinked cellulose ether. Still more preferably, the aqueous light duty liquid detergent formulation of the present invention, comprises: 0.01 to 5 wt % (preferably, 0.05 to 3 wt %; more preferably, 0.075 to 1 wt %; most preferably, 0.1 to 0.5 wt %), based on weight of the aqueous light duty liquid detergent formulation, of a suds enhancing additive; wherein the suds enhancing additive comprises a crosslinked cellulose ether containing 0.1 to 0.6 wt %, based on weight of the crosslinked cellulose ether, of polyether groups; wherein the crosslinked cellulose ether comprises a base cellulose ether and crosslinks; wherein the crosslinks contain the polyether groups; wherein the base cellulose ether is selected from the group consisting of hydroxyethyl methylcellulose, hydroxypropyl methyl cellulose, methyl hydroxyethyl hydroxypropylcellulose, ethyl hydroxyethyl cellulose and combinations thereof and wherein the crosslinked cellulose either is an irreversibly crosslinked cellulose ether. Most preferably, the aqueous light duty liquid detergent formulation of the present invention, comprises: 0.01 to 5 wt % (preferably, 0.05 to 3 wt %; more preferably, 0.075 to 1 wt %; most preferably, 0.1 to 0.5 wt %), based on weight of the aqueous light duty liquid detergent formulation, of a suds enhancing additive; wherein the suds enhancing additive comprises a crosslinked cellulose ether containing 0.1 to 0.6 wt %, based on weight of the crosslinked cellulose ether, of polyether groups; wherein the crosslinked cellulose ether comprises a base cellulose ether and crosslinks; wherein the crosslinks contain the polyether groups; wherein the base cellulose ether is hydroxyethyl methylcellulose and wherein the crosslinked cellulose either is an irreversibly crosslinked cellulose ether.

Preferably, the crosslinked cellulose ether contains 0.1 to 0.6 wt % (preferably, 0.12 to 0.6 wt %; more preferably, 0.12 to 0.45 wt %; most preferably, 0.12 to 0.29 wt %), based on weight of the crosslinked cellulose ether, of polyether groups. More preferably, the crosslinked cellulose ether contains 0.1 to 0.6 wt % (preferably, 0.12 to 0.6 wt %; more preferably, 0.12 to 0.45 wt %; most preferably, 0.12 to 0.29 wt %), based on weight of the crosslinked cellulose ether, of polyether groups; wherein the polyether groups are polyoxyalkylene groups having 2 to 100 (preferably, 2 to 20; more preferably, 3 to 15) oxyalkylene groups per crosslink. Most preferably, the crosslinked cellulose ether contains 0.1 to 0.6 wt % (preferably, 0.12 to 0.6 wt %; more preferably, 0.12 to 0.45 wt %; most preferably, 0.12 to 0.29 wt %), based on weight of the crosslinked cellulose ether, of polyether groups; wherein the polyether groups are polyoxypropylene groups having 2 to 100 (preferably, 2 to 20; more preferably, 3 to 15) oxypropylene groups per crosslink.

Preferably, crosslinked cellulose ether comprises a base cellulose ether having crosslinks containing 0.1 to 0.6 wt %, based on weight of the crosslinked cellulose ether, of polyether groups. Preferably, the base cellulose ether is selected from hydroxyalkyl cellulose ethers, alkyl cellulose ethers and combinations thereof. Examples of base cellulose ethers include, for example, methylcellulose, ethylcellulose, propylcellulose, butylcellulose, hydroxyethyl methylcellulose, hydroxypropyl methylcellulose, hydroxyethylcellulose, ethylhydroxyethylcellulose, methylethylhydroxyethylcellulose, hydrophobically modified ethylhydroxyethylcellulose, hydrophobically modified hydroxyethylcellulose, sulfoethyl methylhydroxyethylcellulose, sulfoethyl methylhydroxypropylcellulose and sulfoethyl hydroxyethylcellulose. Preferably, the base cellulose ethers are mixed cellulose ethers that contain both hydroxyalkyl ether groups and alkyl ether groups, such as, alkyl hydroxyethyl cellulose and hydroxyalkyl methylcellulose (e.g., hydroxyethyl methylcellulose, hydroxypropyl methylcellulose, methyl hydroxyethyl hydroxypropylcellulose and ethylhydroxyethyl cellulose).

Preferably, the base cellulose ether contains hydroxyalkyl ether substitutions. More preferably, the base cellulose ether has a degree of hydroxyethyl ether substitutions, MS (HE), or hydroxypropyl ether substitutions, MS (HP), of 1.5 to 4.5 (preferably, 2.0 to 3.0).

Preferably, the base cellulose ether contains methyl ether substitutions. More preferably, the base cellulose ether has a degree of methyl ether substitution, DS (M), of 1.2 to 2.1 (preferably, 1.3 to 1.7; more preferably, 1.35 to 1.60).

Preferably, the base cellulose ether is a mixed cellulose ether containing hydroxyalkyl ether substitutions and alkyl ether substitutions. More preferably, the base cellulose ether is a mixed cellulose ether having a degree of hydroxyethyl ether substitution, MS (HE), of 0.05 to 0.75 (preferably, 0.15 to 0.45; more preferably, 0.20 to 0.40) and a degree of methyl ether substitution, DS (M), of 1.2 to 2.1 (preferably, 1.3 to 1.7, more preferably, 1.35 to 1.60).

Preferably, the base cellulose ether is a mixed cellulose ether containing hydroxyalkyl ether substitutions and alkyl ether substitutions. More preferably, the base cellulose ether is a mixed cellulose ether having a degree of hydroxypropyl ether substitution, MS (HP), of 0.1 to 1.5 (preferably, 0.2 to 1.2) and a degree of methyl ether substitution, DS (M), of 1.2 to 2.1 (preferably, 1.3 to 2.0).

Preferably, the crosslinked cellulose ether comprises a base cellulose ether having crosslinks containing 0.1 to 0.6 wt %, based on weight of the crosslinked cellulose ether, of polyether groups; wherein the base cellulose ether is a hydroxyethyl methyl cellulose and wherein the crosslinks are polyoxypropylene dioxyethylene ether crosslinks, such as those produced as the reaction product of hydroxyethyl methyl cellulose with polypropylene glycol (PPG) glycidylether.

Crosslinking agents used to crosslink the base cellulose ether to form the crosslinked cellulose ether include compounds having a polyoxyalkylene or polyalkylene glycol group and two or more (preferably, two) crosslinking groups, such as, halogen groups, glycidyl or epoxy groups, and ethylenically unsaturated groups (e.g., vinyl groups) that form ether bonds with the base cellulose ether to form the crosslinked cellulose ether. Preferably, the crosslinking agent is selected from the group consisting of 1,2-dichloro(poly)alkoxy ethers, dichloropolyoxyethylene, diglycidyl polyalkoxy ethers, diglycidyl phosphonate, divinyl polyoxyalkylenes containing a sulphone group. Crosslinking agents having two different types of functional groups can be used. Examples include diglycidyl polyoxypropylenes and glycidyl(poly)oxyalkyl methacrylate. Preferably, the crosslinking agent contains 2 to 100 (preferably, 2 to 20; more preferably, 3 to 15) oxyalkylene groups per molecule.

Preferably, the amount of crosslinking agent included in the crosslinked cellulose ether ranges from 0.0001 to 0.05 eq (preferably, 0.0005 to 0.01 eq; more preferably, 0.001 to 0.005 eq), wherein the unity “eq” represents the molar ratio of moles of the crosslinking agent relative to the number of moles of anhydroglucose units (AGU) in the base cellulose ether.

Preferably, the crosslinked cellulose ether is an irreversibly crosslinked cellulose ether. That is, the crosslinks in the crosslinked cellulose ether do not break down during the intended use of the crosslinked cellulose ether under normal conditions. In contrast, reversible crosslinks will break down during the intended use of the crosslinked cellulose ether under normal conditions. An example of reversible crosslinks in cellulose ethers intended for use in aqueous light duty detergent formulations are those created using aldehyde based crosslinkers (e.g., glyoxal), which crosslinks break down upon dissolution of the crosslinked material in water.

Preferably, the aqueous light duty liquid detergent formulation of the present invention, further comprises an optional ingredient. Preferably, the aqueous light duty liquid detergent formulation of the present invention, further comprises an optional ingredient; wherein the optional ingredient is selected from the group consisting of a dispersant polymer, a salt (e.g., sodium chloride, magnesium sulfate), a builder, an enzyme, a corrosion inhibitor, an acid, a base (e.g., sodium hydroxide), a bleaching agent, an abrasive, an antimicrobial agent (e.g., phenoxyethanol), a chelating agent, an additional surfactant, a pH adjuster, a buffering agent, a dye, a fragrance, a hydrotrope, an organic solvent, a rheology modifier, sulfonated polymer, poly(alkylene oxide) polymer and mixtures thereof.

Preferably, the aqueous light duty liquid detergent formulation of the present invention further comprises a dispersant polymer. More preferably, the aqueous light duty liquid detergent formulation of the present invention further comprises 0.01 to 2 wt % (preferably, 0.05 to 1.5 wt %; more preferably, 0.075 to 1 wt %; most preferably, 0.1 to 0.75 wt %), based on weight of the aqueous light duty liquid detergent formulation, of a dispersant polymer. Most preferably, the aqueous light duty liquid detergent formulation of the present invention further comprises 0.01 to 2 wt % (preferably, 0.05 to 1.5 wt %; more preferably, 0.075 to 1 wt %; most preferably, 0.1 to 0.75 wt %), based on weight of the aqueous light duty liquid detergent formulation, of a dispersant polymer; wherein the dispersant polymer is a polyacrylic acid homopolymer. Preferably, the polyacrylic acid homopolymer has a molecular weight of 1,000 to 7,500 Daltons (preferably, ≥1,500 Daltons; more preferably, ≥2,000 Daltons; still more preferably, ≥3,000 Daltons; most preferably, ≥4,000 Daltons; preferably, ≤7,500 Daltons; more preferably, ≤7,000 Daltons; still more preferably, ≤6,000 Daltons; most preferably, ≤5,000 Daltons).

Preferably, the aqueous light duty liquid detergent formulation of the present invention, further comprises: 0 to 10 wt % (preferably, 0.1 to 10 wt %; more preferably, 0.5 to 7.5 wt %; most preferably, 1 to 5 wt %), based on weight of the aqueous light duty liquid detergent formulation, of a hydrotrope. More preferably, the aqueous light duty liquid detergent formulation of the present invention, optionally further comprises: 0 to 10 wt % (preferably, 0.1 to 10 wt %; more preferably, 0.5 to 7.5 wt %; most preferably, 1 to 5 wt %), based on weight of the aqueous light duty liquid detergent formulation, of a hydrotrope; wherein the hydrotrope is selected from the group consisting of urea; tosylate; calcium, sodium, potassium, ammonium and alkanol ammonium salts of (i) xylene sulfonic acid, (ii) toluene sulfonic acid, (iii) ethylbenzene sulfonic acid and (iv) cumene sulfonic acid; and mixtures thereof. Still more preferably, the aqueous light duty liquid detergent formulation of the present invention, further comprises: 0 to 10 wt % (preferably, 0.1 to 10 wt %; more preferably, 0.5 to 7.5 wt %; most preferably, 1 to 5 wt %), based on weight of the aqueous light duty liquid detergent formulation, of a hydrotrope; wherein the hydrotrope is selected from the group consisting of sodium toluene sulfonate, potassium toluene sulfonate, sodium xylene sulfonate, ammonium xylene sulfonate, potassium xylene sulfonate, calcium xylene sulfonate, sodium cumene sulfonate, ammonium cumene sulfonate and mixtures thereof. Yet more preferably, the aqueous light duty liquid detergent formulation of the present invention, further comprises: 0 to 10 wt % (preferably, 0.1 to 10 wt %; more preferably, 0.5 to 7.5 wt %; most preferably, 1 to 5 wt %), based on weight of the aqueous light duty liquid detergent formulation, of a hydrotrope; wherein the hydrotrope includes sodium xylene sulfonate. Most preferably, the aqueous light duty liquid detergent formulation of the present invention, further comprises: 0 to 10 wt % (preferably, 0.1 to 10 wt %; more preferably, 0.5 to 7.5 wt %; most preferably, 1 to 5 wt %), based on weight of the aqueous light duty liquid detergent formulation, of a hydrotrope; wherein the hydrotrope is sodium xylene sulfonate.

Preferably, the aqueous light duty liquid detergent formulation of the present invention, optionally further comprises: a sulfonated polymer. More preferably, the aqueous light duty liquid detergent formulation of the present invention, optionally further comprises: a sulfonated polymer; wherein the sulfonated polymer is a copolymer of acrylic acid and a sulfonated monomer. Still more preferably, the aqueous light duty liquid detergent formulation of the present invention, optionally further comprises a sulfonated polymer; wherein the sulfonated polymer is a copolymer of acrylic acid and a sulfonated monomer; wherein the sulfonated monomer is selected from the group consisting of 2-acrylamido-2-methylpropane sulfonic acid (AMPS), 2-methacrylamido-2-methylpropane sulfonic acid, 4-styrenesulfonic acid, vinylsulfonic acid, 3-allyloxy sulfonic acid, 2-hydroxy-1-propane sulfonic acid (HAPS), 2-sulfoethyl(meth)acrylic acid, 2-sulfopropyl(meth)acrylic acid, 3-sulfopropyl(meth)acrylic acid, 4-sulfobutyl(meth)acrylic acid and salts thereof. Most preferably, the aqueous light duty liquid detergent formulation of the present invention, optionally further comprises a sulfonated polymer, wherein the sulfonated polymer is a copolymer of acrylic acid and a sulfonated monomer; wherein the sulfonated monomer is selected from the group consisting of 2-acrylamido-2-methylpropane sulfonic acid (AMPS) and salts thereof.

Preferably, the sulfonated polymer has a weight average molecular weight, M_{w}, of 1,000 to 25,000 Daltons (preferably, 5,000 to 20,000 Daltons; more preferably, 7,500 to 17,500 Daltons; most preferably, 10,000 to 15,000 Daltons).

Preferably, the aqueous light duty liquid detergent formulation of the present invention, optionally further comprises a poly(alkylene oxide) polymer. More preferably, the aqueous light duty liquid detergent formulation of the present invention, further comprises 0.005 to 0.5 wt % (preferably, 0.0075 to 0.05 wt %; more preferably, 0.009 to 0.02 wt %), based on weight of the aqueous light duty liquid detergent formulation, of a poly(alkylene oxide) polymer. Still more preferably, the aqueous light duty liquid detergent formulation of the present invention, further comprises 0.005 to 0.5 wt % (preferably, 0.0075 to 0.05 wt %; more preferably, 0.009 to 0.02 wt %), based on weight of the aqueous light duty liquid detergent formulation, of a poly(alkylene oxide) polymer; wherein the poly(alkylene oxide) polymer is selected from the group consisting of poly(ethylene oxide) polymer, poly(propylene oxide) polymer and combinations thereof. Most preferably, the aqueous light duty liquid detergent formulation of the present invention, further comprises 0.005 to 0.5 wt % (preferably, 0.0075 to 0.05 wt %; more preferably, 0.009 to 0.02 wt %), based on weight of the aqueous light duty liquid detergent formulation, of a poly(alkylene oxide) polymer; wherein the poly(alkylene oxide) polymer is a poly(ethylene oxide) polymer having a weight average molecular weight, M_{w}, of 750,000 to 10,000,000 Daltons (preferably, ≥1,000,000 Daltons; more preferably, ≥2,000,000 Daltons; still more preferably, ≥4,000,000 Daltons; preferably, ≤8,000,000 Daltons; more preferably, ≤7,000,000 Daltons; most preferably, ≤6,000,000 Daltons).

Preferably, the aqueous light duty liquid detergent formulation of the present invention, optionally further comprises: 0 to 10 wt % (preferably, 0.01 to 10 wt %; more preferably, 1 to 7.5 wt %; most preferably, 1.5 to 5 wt %), based on the weight of the aqueous light duty liquid detergent formulation, of an organic solvent. More preferably, the aqueous light duty liquid detergent formulation of the present invention, optional further comprises: 0 to 10 wt % (preferably, 0.01 to 10 wt %; more preferably, 1 to 7.5 wt %; most preferably, 1.5 to 5 wt %), based on the weight of the aqueous light duty liquid detergent formulation, of an organic solvent; wherein the organic solvent is miscible with water. Most preferably, the aqueous light duty liquid detergent formulation of the present invention, optionally further comprises: 0 to 10 wt % (preferably, 0.01 to 10 wt %; more preferably, 1 to 7.5 wt %; most preferably, 1.5 to 5 wt %), based on the weight of the aqueous light duty liquid detergent formulation, of an organic solvent; wherein the organic solvent is selected from the group consisting of an aliphatic alcohol (e.g., C₁₋₆ alkanols, C₁₋₆ alkyl diols); a monoalkylene glycol ether (e.g., ethylene glycol propyl ether, ethylene glycol n-butyl ether, ethylene glycol t-butyl ether, propylene glycol propyl ether, propylene glycol n-butyl ether, propylene glycol t-butyl ether, propylene glycol methyl ether acetate, propylene glycol diacetate); a polyalkylene glycol ether (e.g., diethylene glycol ethyl ether, diethylene glycol propyl ether, diethylene glycol n-butyl ether, diethylene glycol t-butyl ether, diethylene glycol hexyl ether, dipropylene glycol methyl ether, dipropylene glycol ethyl ether, dipropylene glycol propyl ether, dipropylene glycol n-butyl ether, dipropylene glycol t-butyl ether, dipropylene glycol phenyl ether, dipropylene glycol methyl ether acetate, tripropylene glycol methyl ether, tripropylene glycol ethyl ether, tripropylene glycol propyl ether, tripropylene glycol n-butyl ether, tripropylene glycol t-butyl ether) and mixtures thereof.

Preferably, the method of manually washing an article of the present invention, comprises: providing a soiled article, wherein the soiled article is selected from the group consisting of at least one of dishware, glassware, flatware, pots and pans (preferably, wherein the article is selected from the group consisting of at least one of dishware, glassware and flatware; preferably, wherein the article is soiled with a greasy food soil); providing an aqueous light duty liquid detergent formulation of the present invention; manually contacting the soiled article with the aqueous light duty liquid detergent formulation to provide a cleaned article; and rinsing the aqueous light duty liquid detergent formulation from the cleaned article.

Some embodiments of the present invention will now be described in detail in the following Examples.

### Synthesis 1: Crosslinked Cellulose Ether

The crosslinking agent used in Synthesis 1 was a linear poly(propyleneglycol) diglycidyl ether made from polypropylene glycol (PPG) having a molecular weight of −400 Daltons and having the formula

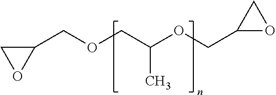

wherein n is 5.7 to 6.7 (available from Leuna-Harze GmbH, Leuna, DE as EPILOX™ M985 poly(propyleneglycol) diglycidylether crosslinker).

Ground cellulose flock (1.5 mol) was added to a 5 L autoclave. After purging the autoclave trice with nitrogen gas, the contents of the autoclave were heated to 40° C. Then dimethylether (DME, 4.7 mol/mol of anhydroglucose units (AGU)) and methyl chloride (MC1; 3.2 mol/mol AGU) were injected into the autoclave. Caustic soda (NaOH, strength 50 wt % aqueous, 1.9 mol NaOH/mol AGU) was added to the autoclave in 3 portions during 2 minutes at a temperature of 40° C. The reaction mixture was held at 40° C. for 30 minutes. Ethylene oxide (0.45 mol/mol AGU) was then added and the reaction mixture was held for 10 minutes at 40° C. The crosslinker (EPILOX™ M985 crosslinker; 0.0025 mol/mol AGU) was dissolved in 20 mL of isopropanol and added to the contents of the autoclave in six increments in 30 second intervals. The contents of the autoclave were then heated to 80° C. in 40 minutes. At 80° C. a water soluble monovalent copper ligand (MCL 2; 1.3 mol/mol AGU) was injected into the autoclave quickly. Afterwards, NaOH (0.67 mol/mol AGU) was added in 7 portions over 30 minutes, followed by a 70 minute cook-off time at 80° C. Following this, the product crosslinked cellulose ether was washed in hot (>95° C.) water, neutralized with formic acid, granulated, dried and milled.

### Comparative Example C1 and Example 1

Aqueous Liquid Hand Dishwashing Detergent Formulations

Aqueous liquid hand dishwashing detergent formulations of Comparative Example C1 and Example 1 were prepared by mixing together the components in the weight proportions noted in TABLE 1 adjusted to pH 8 (as necessary) with sodium hydroxide. The aqueous liquid hand dishwashing detergent formulations of Comparative Example C1 and Example 1 were observed for cleaning performance in hand dishwashing according to the IKW methodology described in Nitsch & Huttman, Recommendation for the Quality Assessment of the Cleaning Performance of Hand Dishwashing Detergents, SOFW Journal; vol. 128, pp. 23-29 (2002)(ISSN 0942-7694). The cleaning performance results are reported TABLE 2.

TABLE 1

Formulation

| | C1 | 1 |
|---|---|---|
| Ingredient | (wt %) | (wt %) |
| Hydrophobically modified alkali soluble | 0.3 | 0.3 |
| acrylic polymer emulsion¹ | | |
| Linear alkyl benzene sulphonic acid (90%) | 7 | 7 |
| NaOH (40%) | 2 | 2 |
| Sodium laureth sulfate (SLES) (70%) | 3 | 3 |
| Cocamidopropyl betaine (CAPB) (40%) | 0.3 | 0.3 |
| Homopolymer of acrylic acid (48%)² | 1.2 | 1.2 |
| MgSO₄ | 0.8 | 0.8 |
| Product Synthesis 1 | — | 0.2 |
| Hydroxyethyl methyl cellulose ether³ | 0.3 | — |
| Fragrance⁴ | 0.1 | 0.1 |
| Dye⁵ (0.1%) | 2 | 2 |
| NaCl | 0.97 | 0.97 |
| Sodium Xylene Sulfonate (40%) | 4 | 4 |
| Deionized Water | q.s. 100 | q.s. 100 |

¹ACUSOL ™ 823 rheology modifier and stabilizer available from The Dow Chemical Company.
²ACUSOL ™ 445 detergent polymer available from The Dow Chemical Company.
³WALOCEL ™ MW 60000 PFV cellulose ether available from The Dow Chemical Company.
⁴Lemon Boost available from Givaudan.
⁵Unicert Yellow 8005 available from Sensient Cosmetic Technologies.

TABLE 2

| Aqueous liquid hand dishwashing | Yield/Foam |
|---|---|
| detergent formulation | Mileage |
| Comparative Example C1 | 3 |
| Example 1 | 3.5 |
| Commercial benchmark¹ | 2.5 |

¹FEBA dishwashing liquid.

We claim:

1. An aqueous light duty liquid detergent formulation, comprising:
water;
a cleaning surfactant; and
a suds enhancing additive; wherein the suds enhancing additive comprises a crosslinked cellulose ether containing 0.1 to 0.6 wt %, based on weight of the crosslinked cellulose ether, of polyether groups.

2. The aqueous light duty liquid detergent formulation of claim 1, wherein the crosslinked cellulose ether is an irreversibly crosslinked cellulose ether.

3. The aqueous light duty liquid detergent formulation of claim 2, wherein the polyether groups in the irreversibly crosslinked cellulose ether are polyoxyalkylene groups having 2 to 100 oxyalkylene groups.

4. The aqueous light duty liquid detergent formulation of claim 3, wherein the polyoxyalkylene groups are selected from the group consisting of a polyoxyethylene, a polyoxypropylene and combinations thereof.

5. The aqueous light duty liquid detergent formulation of claim 4, wherein the irreversibly crosslinked cellulose ether comprises a base cellulose ether and crosslinks; wherein the crosslinks contain the polyether groups; and wherein the base cellulose ether contains hydroxyalkyl ether and alkyl ether groups.

6. The aqueous light duty liquid detergent formulation of claim 5, wherein the base cellulose ether is selected from the group consisting of hydroxyethyl methylcellulose, hydroxypropyl methyl cellulose, methyl hydroxyethyl hydroxypropylcellulose, ethyl hydroxyethyl cellulose and combinations thereof.

7. The aqueous light duty liquid detergent formulation of claim 2, wherein the cleaning surfactant includes an anionic surfactant.

8. The aqueous light duty liquid detergent formulation of claim 2, wherein the cleaning surfactant is a mixture of an anionic surfactant and an amphoteric surfactant.

9. The aqueous light duty liquid detergent formulation of claim 1, further comprising an optional ingredient selected from the group consisting of a dispersant polymer, a salt, a builder, an enzyme, a corrosion inhibitor, an acid, a base, a bleaching agent, an abrasive, an antimicrobial agent, a chelating agent, an additional surfactant, a pH adjuster, a buffering agent, a dye, a fragrance, a hydrotrope, an organic solvent, a rheology modifier, sulfonated polymer, poly(alkylene oxide) polymer and mixtures thereof.

10. A method of manually washing an article, comprising:
providing a soiled article, wherein the soiled article is selected from the group consisting of at least one of dishware, glassware, flatware, pots and pans;
providing an aqueous light duty liquid detergent formulation of claim 2;
manually contacting the soiled article with the aqueous liquid hand dishwashing detergent formulation to provide a cleaned article; and
rinsing the aqueous light duty liquid detergent formulation from the cleaned article.
